(19) United States
(12) Patent Application Publication
(10) Pub. No.: US 2021/0009369 A1
(43) Pub. Date: Jan. 14, 2021

(54) POP-UP SHEET DISPENSER

(71) Applicant: 3M INNOVATIVE PROPERTIES COMPANY, St Paul, MN (US)

(72) Inventor: James E. Nash, Bloomington, MN (US)

(21) Appl. No.: 16/975,063

(22) PCT Filed: Feb. 19, 2019
(86) PCT No.: PCT/IB2019/051335

§ 371 Date: Aug. 21, 2020

Related U.S. Application Data
(60) Provisional application No. 62/635,904, filed on Feb. 27, 2018.

(51) Int. Cl. B65H 1/04; B42D 5/00

(52) U.S. Cl. CPC B65H 1/04; B42D 5/005

(57) ABSTRACT

A dispenser that includes first and second rigid, weighted rocker assemblies that are each hingedly connected to a base of the dispenser.

### BACKGROUND

Dispensers for sequentially dispensing individual sheets of paper from a fan-folded stack are widely used. Such dispensers are often referred to as “pop-up” dispensers, in which removing an uppermost sheet from the dispenser causes an underlying sheet to be popped up into a position in which it is ready for removal.

### SUMMARY

In broad summary, herein is disclosed a dispenser comprising first and second rigid, weighted, rocker assemblies that are each hingedly connected to a base of the dispenser. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a side/top perspective view of an exemplary dispenser as disclosed herein, with a fan-folded stack of sheets of paper loaded in the dispenser.

FIG. 2 is a side/top perspective view of the exemplary dispenser of FIG. 1, with the paper stack omitted.

FIG. 3 is a repeat of FIG. 2 with additional features being pointed out.

FIG. 4 is a side view, viewed along the transverse axis, of an exemplary dispenser as disclosed herein, with the paper stack omitted.

FIG. 5 is a side view of the exemplary dispenser of FIG. 4 with the rocker assemblies rotated outward.

FIG. 6 is a side schematic cross-sectional view of an exemplary dispenser with a fan-folded stack of sheets of paper loaded in the dispenser, and with a leading sheet of paper in position for dispensing.

FIG. 7 is a side schematic cross-sectional view of the dispenser of FIG. 6, showing the leading sheet of paper in the act of being removed from the dispenser.

FIG. 8 is a side schematic cross-sectional view of the dispenser of FIG. 7, with the leading sheet of paper having been removed from the dispenser but not yet having been separated from the following sheet of paper.

FIG. 9 is a side/top perspective view of another exemplary dispenser as disclosed herein, with the paper stack omitted.

FIG. 10 is a side/top perspective view of another exemplary dispenser as disclosed herein, with the paper stack omitted.

FIG. 11 is a side/top perspective view of still another exemplary dispenser as disclosed herein, with the paper stack omitted.

FIG. 12 is a side/bottom perspective view of the exemplary dispenser of FIG. 11.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

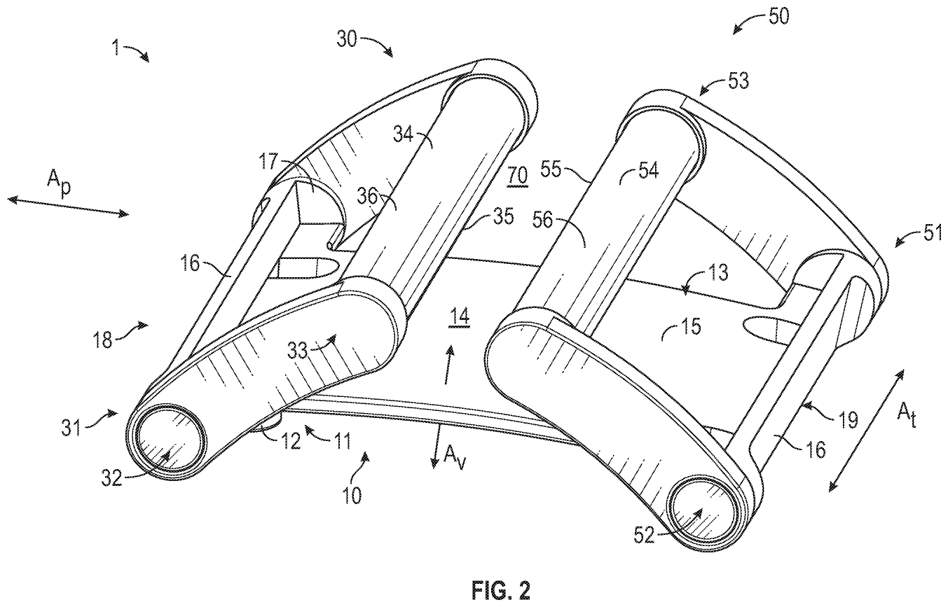

Terms such as vertical, top, bottom, upper, lower, under, over, above, beneath, and so on, have their customary meaning with respect to the herein-disclosed dispenser when positioned on a horizontal surface for ordinary use. With the dispenser in such a position, the vertical axis of the dispenser will have its customary meaning with respect to the Earth's gravity and is indicated as axis Aᵥ in FIG. 2. (The primary and transverse axes of the dispenser are defined and described in detail later herein.) Terms such as first and second are used in their relative sense, for convenience of description, and may often refer to items that are similar or identical except for their order of description.

As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). The term “substantially”, unless otherwise specifically defined, means to a high degree of approximation (e.g., within +/−10% for quantifiable properties). The term “essentially” means to a very high degree of approximation (e.g., within plus or minus 2% for quantifiable properties; it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match. The term “configured to” and like terms is at least as restrictive as the term “adapted to”, and requires actual design intention to perform the specified function rather than mere physical capability of performing such a function. All references herein to numerical parameters (dimensions, ratios, and so on) are understood to be calculable (unless otherwise noted) by the use of average values derived from a number of measurements of the parameter, particularly for the case of a parameter that is variable.

### DETAILED DESCRIPTION

Disclosed herein is a dispenser 1 for dispensing sheets of paper from a fan-folded stack 100 of sheets of paper.

By a fan-folded stack is meant a stack of paper sheets in which all the sheets of the stack are of the same size and shape, and in which each sheet comprises a bottom major surface provided with a relatively narrow (e.g., 1.5 cm or less) stripe of pressure-sensitive adhesive proximate to a primary end of the sheet and extending transversely along the primary end of the sheet. By a fan-folded stack is further meant that the sheets are stacked so that the stripes of adhesive are at opposite ends of the sheets, on successive sheets of the stack. It will be understood that such a “fan-folded” stack of sheets does not comprise a single elongate sheet with actual folds or creases; rather, the successive sheets are joined at their opposing ends by the adhesive stripes so that if the stack is stretched slightly along its thickness dimension it will expand to resemble a fan-folded or Z-folded configuration.

Sheets of this type are well known (e.g. as available from 3M Company, St. Paul, under the trade designation POST-IT POP-UP NOTES) and are described e.g. in U.S. Pat. Nos. 4,416,392, 5,158,205, and 5,526,955, which are incorporated by reference herein for this purpose. Many such sheets use a pressure-sensitive adhesive composition that is repositionable so that after being dispensed and attached to an item, the sheet can be removed and repositioned if desired. Many such sheets are available in stacks of e.g. 45-50 to 90-100 sheets. Common configurations include stacks that are approximately 3″×3″ (7.6 cm×7.6 cm) in size and that are approximately one-quarter inch or 0.04 inches vertical height. (A stack may have any suitable dimensions, and does not have to be perfectly square.) A fan-folded stack of paper sheets as disclosed herein will be distinguished from e.g. a fan-folded stack of synthetic polymeric sheets (e.g. comprised of cellulose acetate or the like) that are typically smaller in size and significantly more limp and flexible than paper sheets, and are used e.g. as page-marking flags and the like.

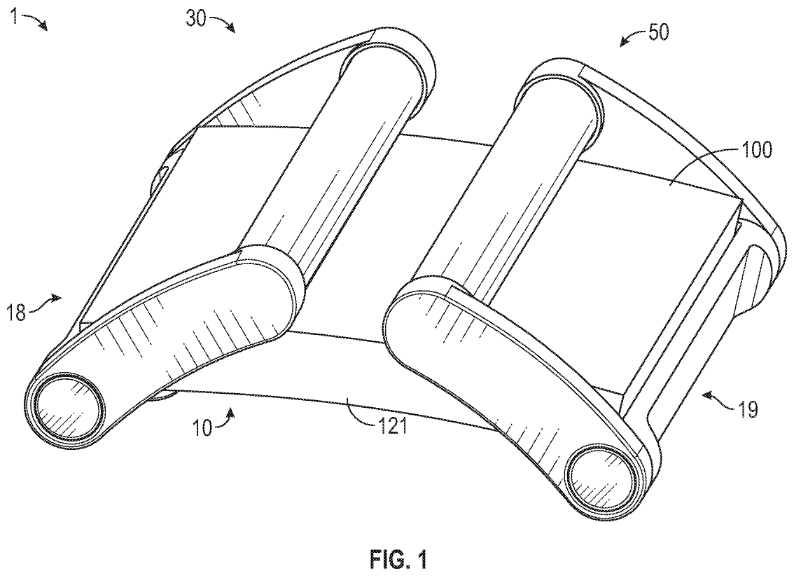

A dispenser 1 as disclosed herein is shown in exemplary embodiment in FIG. 1 with a fan-folded stack 100 of sheets of paper installed therein; dispenser 1 is shown in FIG. 2 with the stack of paper omitted so that details of dispenser 1 may be more easily seen. Dispenser 1 comprises a vertical axis Av, a primary axis Aₚ, and a transverse axis Aₜ, all as indicated in FIG. 2. As is discussed later in detail, dispenser 1 comprises two rocker assemblies (30 and 50 of FIGS. 1 and 2) that are able to be rotated back and forth along dispenser 1. This direction of rotation of the rocker assemblies along dispenser 1 is termed the primary axis of dispenser 1 as indicated by arrow Aₚ of FIG. 2. The direction that is parallel to the axes of rotation 32 and 52 of rocker assemblies 30 and 50 is termed the transverse axis Aₜ, which is orthogonal to the primary axis and to the vertical axis, all of which is easily understood with reference to FIG. 2. Directions such as inward and outward are with respect to the primary axis Aₚ of dispenser 1, with inward indicating a direction toward the center of dispenser 1 (e.g. toward the location occupied by the reference number 14 in FIG. 2) and with outward indicating a direction away from the center of the dispenser and toward a primary end of the dispenser.

Dispenser 1 comprises a base 10 with a lower portion 11 that is configured to rest on a horizontal surface (e.g. a tabletop, desktop, countertop, etc.). In many convenient embodiments, lower portion 11 may comprise e.g. four legs 12 for such purposes. Base 10 comprises an upper portion 13 that is configured to provide a space 14 to receive and support a fan-folded stack 100 of sheets of paper. In some embodiments space 14 may be bounded on all sides, e.g. so that it takes the form of an upwardly-open-ended cavity defined by four walls and a floor, such that when the paper stack 100 is installed therein, no sidewall of the stack is exposed. In other embodiments, space 14 may comprise a relatively open-sided configuration in which one or more sidewalls of the paper stack is an exposed sidewall that is easily visible rather than being covered by a wall of base 10. For example, in the exemplary design of FIG. 1, transverse sidewall 121 of paper stack 100 is an exposed sidewall.

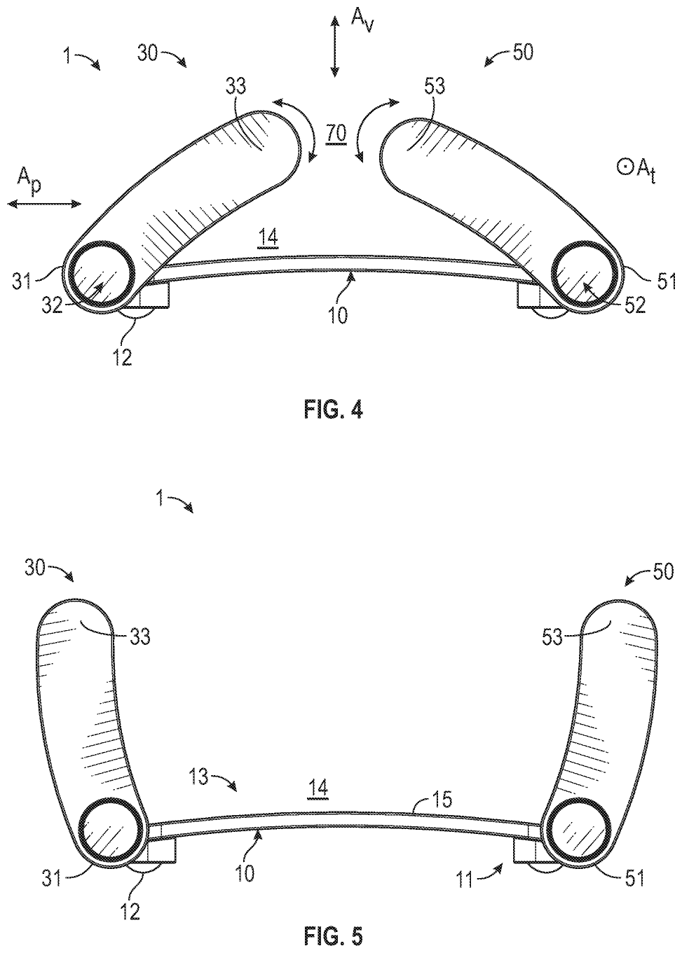

In further detail, the exemplary design of FIGS. 1 and 2 comprises endwalls 16 at first and second primary ends 18 and 19 of dispenser 1, which endwalls closely outwardly abut the primary ends of paper stack 100 to prevent the paper stack from sliding along the primary axis of dispenser 1. (In this regard the designs disclosed herein will be distinguished from dispensers that are configured to hold a stack so that the stack can slide back and forth in a reciprocating manner.) Dispenser 1 as shown in FIG. 2 further comprises partial transverse sidewalls 17, which can closely abut at least an end portion of the transverse sidewalls of the paper stack. Upper surface 15 of upper portion 13 of base 10 provides a floor upon which the bottom of a paper stack rests. In many embodiments, upper surface 15 may be at least slightly arcuate in a convex-up manner (e.g. as is evident in the side view of FIG. 4) e.g. to impart a slight, constant curvature to the paper stack which may enhance the ability of the paper stack to avoid occasional spontaneous flexing (so-called “oilcanning”)

As depicted in FIG. 2, exemplary dispenser 1 comprises a first rigid, weighted rocker assembly 30 with a proximal end 31 that is hingedly connected via a hinged connection 32 to a first primary end 18 of base 10. Rocker assembly 30 further comprises a distal end 33 that comprises a first sheet-contacting member 34. Dispenser 1 likewise comprises a second rigid, weighted rocker assembly 50 with a proximal end 51 that is hingedly connected via a hinged connection 52 to a second primary end 19 of base 10. Rocker assembly 50 likewise comprises a distal end 53 that comprises a second sheet-contacting member 54. In some embodiments rocker assemblies 30 and 50 may be substantially or essentially identical (i.e., mirror images of each other, as in FIG. 2); however, this is not strictly necessary.

By a rocker assembly is meant an assembly with a proximal end that is hingedly connected to a primary end of dispenser 1 so that a distal end of the assembly can be rotatably moved back and forth. At various points along the motion path, the distal end may be moving in a generally vertical direction, in a direction along the primary axis of the dispenser, or a combination of both. By a rigid rocker assembly is meant that the rocker assembly is configured (e.g. made of relatively inflexible materials) so that the rotation about the axis of rotation occurs by way of the entire assembly moving bodily, as a unit. This is contrasted to, for example, an assembly that includes flexible materials such that at least portions of the assembly will deform significantly rather than the entire assembly moving as a unit. By a weighted rocker assembly is meant that the assembly comprises sufficient mass, positioned far enough away from the axis of rotation of the assembly, to bias the distal end of the rocker assembly down toward the upper surface of a paper stack with appropriate force. (By definition, a weighted rocker assembly as disclosed herein will exhibit a total mass of at least 50 g.) Often, such a mass may be provided in the form of a mass element (e.g. mass elements 36 and 56 as depicted in FIG. 2) that is made of a high-density material such as e.g. metal. In some embodiments a mass element may take the form of a hollow container (e.g. a molded hollow cylinder) that is loaded with sand, metal shot, or the like.

The hinged connection 32 of first rocker assembly 30 to first primary end 18 of base 10 will establish a first rotation axis of first rocker assembly 30; the hinged connection 52 of second rocker assembly 50 to second, opposing primary end 19 of base 10 will establish a second rotation axis of second rocker assembly 50. In many embodiments, the first rotation axis and the second rotation axis will be parallel to each other and will both be aligned with the transverse axis of the dispenser as in the exemplary design of FIG. 2. In some embodiments, each such hinged connection will be in the form of a multi-piece hinge. By this is meant a hinge or bearing that is provided collectively by two (or more) individually-made pieces that are fitted together, e.g. to form a so-called pin-knuckle hinge, a barrel hinge, and so on. In other embodiments each such hinged connection may be a so-called living hinge in which the hinge components are portions of a single, integrally-molded unit.

By definition, first and second rocker assemblies 30 and 50 operate independently of each other. That is, rotatable movement of one rocker assembly will not cause the other rocker assembly to move; moreover, one rocker assembly will not act to prevent the other rocker assembly from moving. This precludes the first and second rocker assemblies from being operatively connected to each other e.g. by one or more pushrods, cables or the like.

Returning to rocker assembly 30 as shown in FIGS. 1 and 2, the weight of rocker assembly 30 will exhibit a downwardly-biasing force that will cause a sheet-contacting surface 35 of sheet-contacting member 34 to be held in contact with an upper surface of paper stack 100. Likewise, sheet-contacting surface 55 of sheet-contacting member 54 will be held in contact with an upper surface of paper stack 100. As depicted in the side view of FIG. 4, each rocker assembly 30 and 50 can be rotated (as indicated by the curved arrows in FIG. 4) back and forth about its hinged connection to base 10. For much of the time (i.e. when a paper sheet is not being dispensed), rocker assemblies 30 and 50 may be in a “resting” configuration (e.g. as shown in FIG. 1) in which their weight holds them down upon the upper surface of the paper stack.

The use of weighted rocker assemblies as disclosed herein provides that the sheet-contacting member of each rocker assembly is biased toward contact with the upper surface of the paper stack, even when the stack is e.g. down to a few sheets of paper. This can advantageously allow that conventional methods that are often used to maintain a paper stack in a proper position in a dispenser (e.g., using a spring-loaded platen underneath the paper stack to urge the stack upwards in its entirety; or, using a weighted ballast platen above the paper stack to urge the stack downwards in its entirety) are not necessarily needed in the present dispenser. In some embodiments, no such spring-loaded platen is present; in some embodiments, no such weighted platen (i.e. that exerts force on the entire area of the paper stack except for a slot provided through the weighted platen through which sheets can be dispensed) is present.

In some embodiments rocker assemblies 30 and 50 may each be rotatable so far outward (along the primary axis of dispenser 1) that no part of either rocker assembly vertically overlaps space 14 that receives paper stack 100. Such a configuration is shown in exemplary embodiment in FIG. 5. This can allow that a new or replacement paper stack can be installed into dispenser 1 by inserting the stack vertically downward into space 14 from above. In other embodiments, the outward rotation of the rocker assemblies may be limited; in such cases they may merely be rotated far enough upward and/or outward that a new or replacement paper stack can be inserted by sliding the stack e.g. transversely into space 14. Any such arrangement allows that dispenser 1 may be a refillable dispenser into which a replacement paper stack may be loaded, in contrast to disposable dispensers which are discarded or recycled once their initial stack of paper sheets is exhausted.

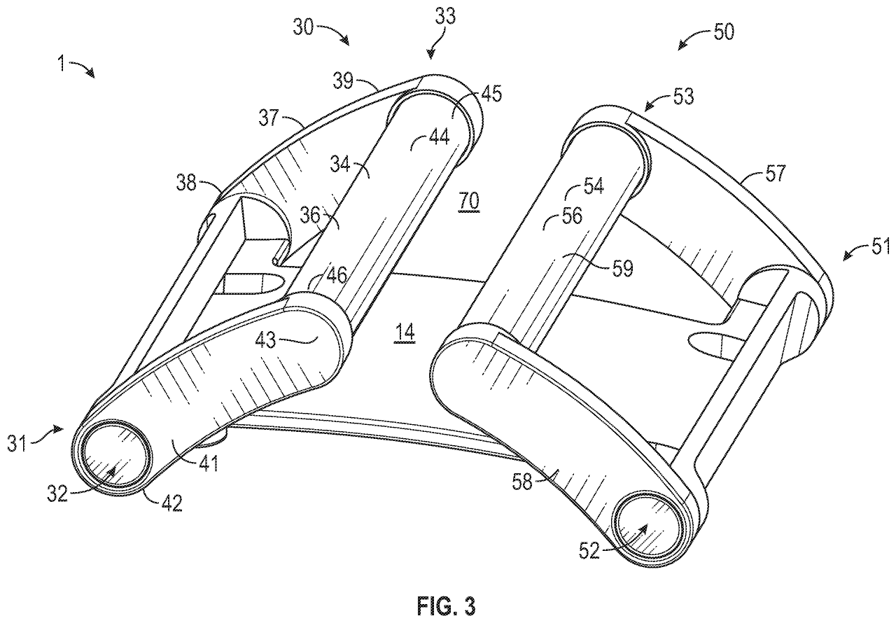

Sheet-contacting members 34 and 54 of rocker assemblies 30 and 50 collectively define a dispensing slot 70, as shown e.g. in FIGS. 2 and 4. Dispensing slot 70 will be at least generally centrally located along the primary axis of dispenser 1 (as is evident in FIG. 4). When the rocker assemblies are in their resting configuration, slot 70 will typically exhibit a transverse length that is greater than the width of slot 70 along the primary axis of dispenser 1 (as is evident in FIG. 3). However, as discussed in detail below, the width of dispensing slot 70 along the primary axis of dispenser 1 can be temporarily increased during the process of dispensing a sheet of paper therethrough, which provides significant advantages.

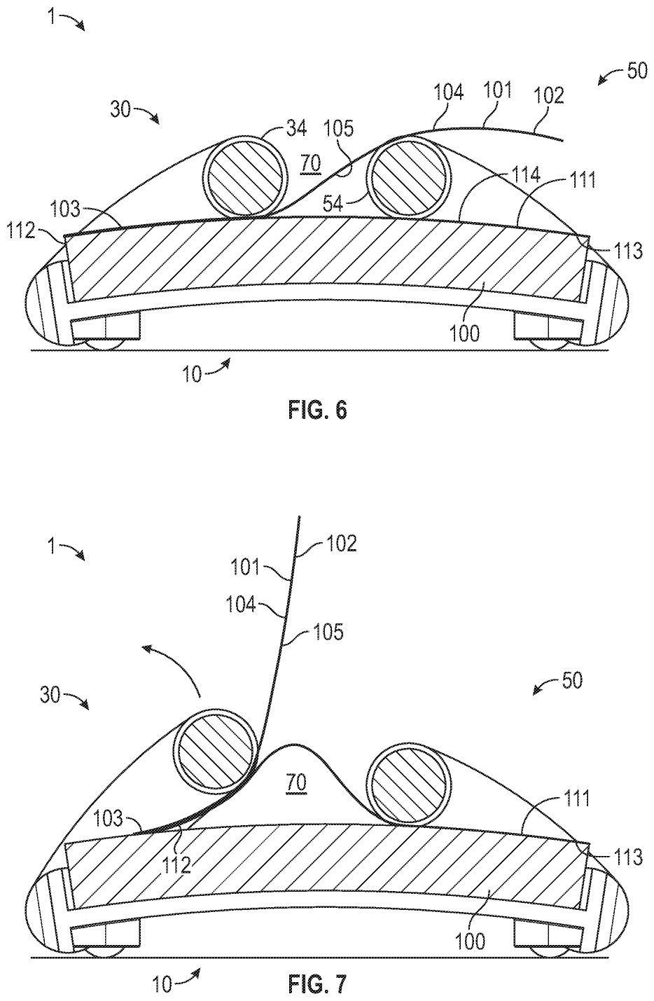

The operation of dispenser 1 to dispense individual sheets of paper from stack 100 can be ascertained with reference to FIGS. 6-8. It is emphasized that the design of dispenser 1 shown in these figures is merely one representative example and that many variations are possible, as discussed in detail later herein.

FIG. 6 depicts exemplary dispenser 1 with a stack 100 of paper sheets installed therein. A leading sheet (that is, an uppermost sheet, which will be the sheet to be dispensed) 101 is positioned so that leading end 102 (that is, an end that can be grasped by a user) protrudes generally upward through slot 70 between the sheet-contacting members 34 and 54 of rocker assemblies 30 and 50. Leading end 102 may e.g. protrude more or less straight up from slot 70, or it may tend to lean to one side e.g. as shown in FIG. 6, depending e.g. on the stiffness of the particular paper that is used, the design (e.g. the width) of the slot, etc. A portion of sheet-contacting surface 35 of sheet-contacting member 34 of rocker assembly 30 rests upon a portion of upper surface 104 of “leading” sheet 101. A portion of sheet-contacting surface 55 of sheet-contacting member 54 of rocker assembly 50 rests upon a portion of the upper surface 114 of “following” sheet 111, which is the next sheet in line to be dispensed after sheet 101. (With leading sheet 101 in this configuration, the upper surface of stack 100 will be provided in part by upper surface 104 of leading sheet 101 and in part by upper surface 114 of following sheet 111).

With reference to FIG. 7, to dispense a sheet 101 from dispenser 1, a user may grasp leading end 102 of leading sheet 101 and pull it generally upward. Since a stripe of adhesive connects the lower surface 105 of trailing end 103 of leading sheet 101 to the upper surface 114 of end 112 of following sheet 111, this pulling force will urge end 112 of following sheet 111 inward along the primary axis of dispenser 1. This will cause following sheet 111 to buckle upwards into slot 70 in the general manner shown in FIG. 7. This step is typically the highest-force step of the dispensing process and is the reason that pop-up dispensers often comprise a considerable amount of ballast weight to prevent the dispenser from lifting upward or tipping during this step. However, the arrangements disclosed herein allow rocker assembly 30 to rotate upward and rearward during this process, thus temporarily increasing the width of slot 70 as well as moving the sheet-contacting member 34 of rocker assembly 30 upward. Such arrangements can allow the process of buckling a following sheet of paper in order to dispense a leading sheet of paper to be a rather gentle, low-curvature process, which can lower the force required for this process to be performed. Since this can minimize the chances of the dispenser being lifted upward during the dispensing process, it can allow the total weight of the dispenser to be minimized. In other words, there may be no need for any extra ballast weight to be present in dispenser 1, and in fact the weight of the mass elements and/or the total weight of the dispenser may be minimized. The arrangements disclosed herein thus advantageously facilitate one-handed dispensing (without the dispenser having to be held down by the other hand of the user) without the dispenser having to be held down e.g. by extra ballast weight or by a suction cup.

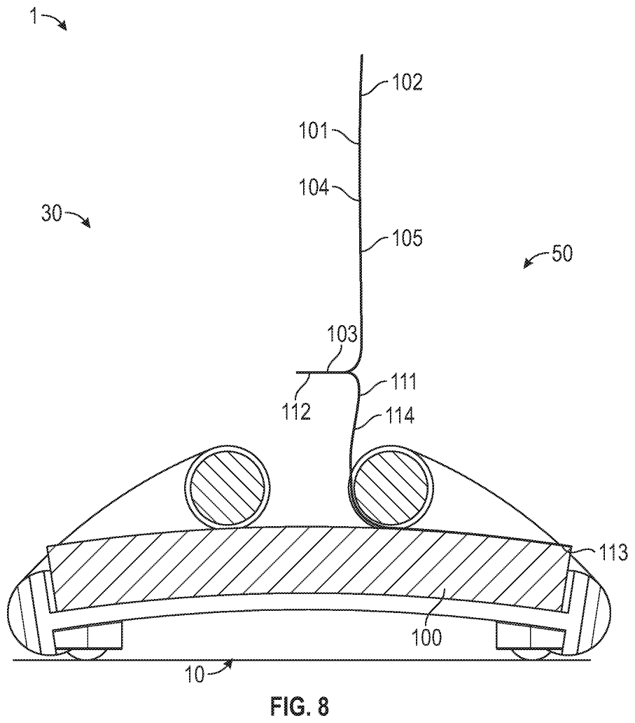

Continuing to FIG. 8, continued upward pulling force on leading paper sheet 101 causes trailing end 103 of leading sheet 101, and end 113 of following sheet 111, to be pulled clear of rocker assembly 30, which allows rocker assembly 30 to rotate downward and thus return to its resting condition as shown in FIG. 8. At this point trailing end 103 of leading sheet 101 and end 112 of following sheet 111 are still joined by the stripe of adhesive that bonds their respective surfaces 105 and 114 as shown in FIG. 8. Continued upward pulling force on sheet 101 will overcome this adhesive bond and will thus separate sheet 101 from sheet 111.

To achieve this, dispenser 1 is configured so that the downward force exerted by rocker assembly 50 ensures that the holding force exerted by rocker assembly 50 on following sheet 111 is greater than the adhesive bonding force between sheets 101 and 111. Specifically, the downward force exerted by rocker assembly 50 will ensure that the frictional force between the sheet-contacting surface 55 of sheet-contacting member 54 of rocker assembly 50 and the upper surface 114 of sheet 111 is sufficiently high to ensure that the adhesive bond between sheets 101 and 111 is broken rather than sheet 111 being inadvertently removed from the dispenser.

Such arrangements will ensure that sheets 101 and 111 are separated from each other rather than encountering an undesired double-dispensing of two (or more) sheets. The sheet-separation step is typically a lower-force process than the above-described sheet-buckling. Thus, while rocker assembly 50 may rotate slightly upward and outward (not shown in FIG. 8) during the sheet-separation process, it typically will not do so to the same degree that rocker assembly 30 rotates upward and outward during the buckling process.

Upon separation of sheet 101 from sheet 111, rocker assembly 50 will rotate downward and thus will return to its resting condition. At this point, sheet 101 has been dispensed and sheet 111 now becomes the leading sheet, with a leading end 112 and a trailing end 113, and is ready to be dispensed in the manner described above, except that the roles of rocker assemblies 30 and 50 will be reversed. The above-described dispensing steps can be performed repeatedly, with the positions of rocker assemblies 30 and 50 automatically adjusting to the decreased height of stack 100 as sheets are dispensed.

It will be appreciated that the arrangements disclosed herein can allow a significant portion of the weight of a dispenser 1 to be provided in the form of mass elements on rocker assemblies that are hingedly connected to the base of the dispenser. Such arrangements can allow the total weight of the dispenser to be minimized, for example they may negate any need to use a ballast weight as discussed above. Moreover, the fact that each rocker assembly can deflect upward and outward during the dispensing process can allow for a more gradual upward turn of a sheet as it is being dispensed (as is evident from sheet 101 of FIG. 7). This can advantageously minimize any curling of the dispensed sheet. Furthermore, in some embodiments each sheet-contacting member (e.g. 34 and 54) may comprise a sheet-contacting surface (e.g. 35 and 55) that is arcuate (e.g. gently curved) along the primary axis of the dispenser as in the exemplary design of FIG. 2, which may enhance such effects. In many embodiments, of course, each sheet-contacting member may be planar along the transverse axis of the dispenser, again as in FIG. 2.

As is evident from FIGS. 1-3, in some embodiments a sheet-contacting element such as elements 34 and 54 may take the form of a cylinder. In some such cases, such a cylinder may be rotatably installed so that it can rotate under the friction of a sheet passing thereagainst; however, in many embodiments such a cylinder may be fixed in position. In some embodiments, a sheet-contacting member may comprise e.g. a semi-circular sheet-contacting surface; in general, any surface that is arcuate along the primary axis of the dispenser may be used if desired. In other embodiments, a sheet-contacting surface may be flat, may consist of a series of beveled or chamfered flats, and so on. Regardless of the specific geometrical structure of the sheet-contacting surface, frictional properties of the sheet-contacting surface as imparted by e.g. surface roughness, chemical composition, surface treatments, and so on may be adjusted as desired in order to achieve the effects disclosed herein.

From the discussions above it will be appreciated that the weight of each rocker assembly (e.g. assemblies 30 and 50) can be chosen in view of the properties of the paper stack that is to be dispensed (e.g., the length and width of the paper, the stiffness of the paper, the width of the adhesive stripes that bond the sheets together, the strength of the adhesive that is used, and so on). In various embodiments, a rocker assembly may exhibit a total weight of at least 50, 70, 90, 110, or 130 grams. In further embodiments, a rocker assembly may exhibit a total weight of at most 160, 140, 120, 100, or 80 grams. In further embodiments, dispenser 1 may exhibit a total weight of at most 500, 400, 350, 300, or 260 grams. It will be understood that such properties will distinguish a herein-disclosed dispenser from, e.g., very lightweight dispensers made of flexible plastic (not filled with a high-density filler as disclosed herein), paperboard, or card stock (e.g. as disclosed in U.S. Pat. Nos. 5,653,666, 5,158,205, 5,769,270, 6,688,488, 8,261,937). Such lightweight dispensers often require two-handed operation or require the use of a suction cup, an adhesive backing, or the like, to prevent lifting or tipping during operation. In various embodiments a rocker assembly may exhibit a length of at least about 2, 3, 4 or 5 cm; in further embodiments a rocker assembly may exhibit a length of at most about 7, 6, 5, or 4 cm. Such a length is defined as the linear distance from the axis of rotation of the rocker assembly to the farthest-distal point of the sheet-contacting surface of the rocker assembly.

Returning to FIG. 2 as a specific example, in many embodiments a mass element (e.g. elements 36 and 56) of a rocker assembly may be positioned at or near a distal end (i.e., an end farthest from the hinged connection) of the rocker assembly. In some embodiments, a mass element (e.g. 36 and 56) itself may actually serve as a sheet-contacting member (e.g., 34 and 54) and thus may comprise a sheet-contacting surface (e.g. 35 and 55), as in the design of FIG. 2.

In further detail with specific reference to FIG. 3, the exemplary design depicted therein includes a first rocker assembly 30 that comprises first and second arms 37 and 41 that are transversely spaced apart from each other to provide a transverse gap therebetween. Arm 37 comprises a proximal end 38 that is hingedly connected to first primary end 18 of base 10. Arm 41 similarly comprises a proximal end 42 that is hingedly connected to first primary end 18 of base 10. Arms 37 and 41 thus collectively provide the hinged connection 32 of first rocker assembly 30 to base 10. In the exemplary depicted embodiment, a mass element 36 of first rocker assembly 30 takes the form of an elongate member 44 that is positioned at the distal end of arms 37 and 41 and that extends along the transverse axis of dispenser 1 to span the transverse gap between first and second arms 37 and 41, with a first transverse end 45 of member 44 being connected to a distal end 39 of first arm 37 and with a second transverse end 46 of member 44 being connected to a distal end 43 of second arm 41, all as pointed out in FIG. 3. Similar arrangements can be made for second rocker assembly 50, as is evident from FIG. 3. Although these are not described in specific detail, it will be understood that the above descriptions of rocker assembly 30 can likewise be applied to rocker assembly 50.

A mass element of a rocker assembly can take any suitable geometric form, shape, size, aspect ratio, etc., and can be made of any suitable material. In some embodiments a mass element may be made of metal, e.g. iron or steel. In some embodiments a mass element may be made of a molded organic polymeric material that is filled with a high-density filler (i.e. a filler that exhibits a density of at least 2.5 g/cc). Such a high-density filler might be e.g. a mineral filler or a fine-powder metal filler. For example, a suitable high-density filler might be barium sulfate, which may be compounded into any suitable organic polymeric material that is e.g. injection-moldable. Any such filler may be used at any loading in the organic polymeric material that will provide a satisfactory overall density and weight. In various embodiments such a filler may be present so as to make up at least about 30, 50, 70, or 80% of the mass of the molded component in which the filler is present.

In some embodiments, a mass element (such as e.g. mass element 36 of FIGS. 2 and 3) may be a separately made component (whether e.g. comprised of metal or of an injection-molded, highly-filled polymer) that is attached to arms 37 and 41. For example, arms 37 and 41 may be made of any moldable thermoplastic organic polymeric material (not necessarily a highly filled material), with mass element 36 being e.g. a solid steel cylinder that is attached thereto. In some embodiments, some or all of the components of a rocker assembly may be molded as a single, integral unit. For example, mass element 36 and arms 37 and 41 may be portions of a single piece of highly-filled, molded, organic polymeric material. In such cases generally all portions of such a rocker assembly may serve as a mass element. (It will be understood that portions that are farthest from the hinged connection of the rocker assembly to the dispenser base may be the most effective in applying force to the paper stack.) In some embodiments, highly-filled molded organic polymeric components (e.g. arms 37 and 41) may be used in combination with a metal mass element (e.g. element 36).

In various embodiments, a mass element of a rocker assembly may comprise an average density of at least 2.5, 3.0, 5.0, or 7.0 g/cm. In various embodiments, a mass element that comprises a highly-filled organic polymeric material may use a filler (e.g. an inorganic mineral filler such as barium sulfate) that has an average density of at least about 2.5, 3.0, 5.0, or 7.0 g/cm.

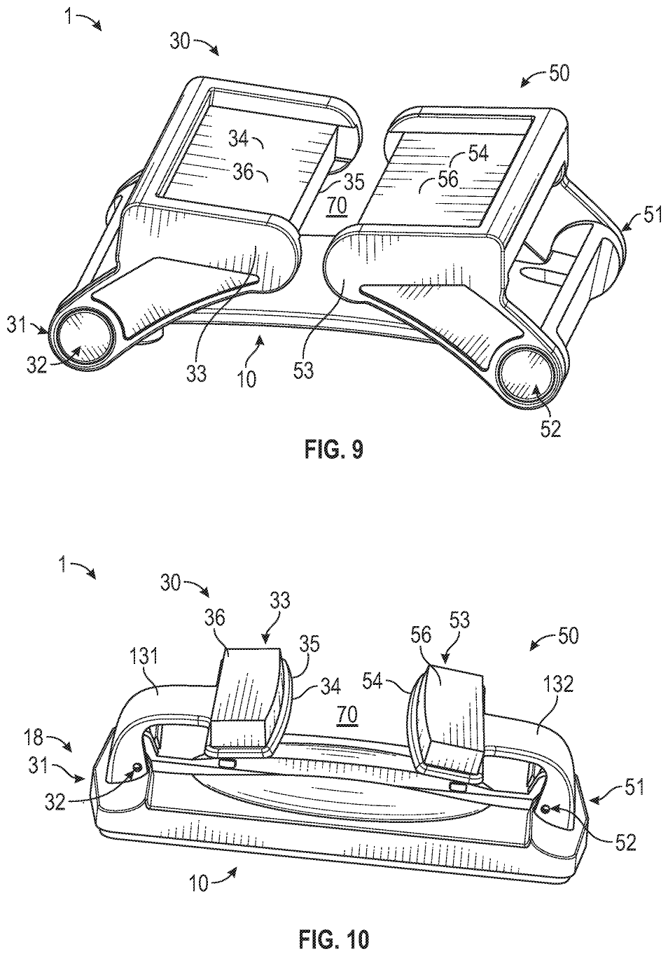

As emphasized throughout this document, the design shown in FIGS. 1-8 is an exemplary design that is particularly suitable for a description of the functioning of a dispenser that comprises weighted rocker assemblies. Any suitable variations may be envisioned. For example, rather than a sheet-contacting member (and mass element) 34/36 being an elongate cylinder, such a member/element 34/36 may take the form shown in FIG. 9. That is, it may exhibit the shape of a bar, block or slab, or any other suitable shape. Furthermore, although in many embodiments the sheet-contacting surface of a sheet-contacting member may be smoothly arcuate as with sheet-contacting surface 35 of sheet-contacting member 34 of FIG. 3, in some embodiments the sheet-contacting surface it may be more sharp-cornered, e.g. as with surface 35 of FIG. 9. (Regardless of the specific design, it will be evident from the discussions herein that only a part of a sheet-contacting surface may be in contact with a surface of a paper sheet at any given time and that areas of the surface may be in contact with the surface of the paper sheet during different steps of the dispensing process.)

Still further, rather than a rocker assembly having first and second transversely spaced arms as described earlier herein, in some embodiments a rocker assembly can take the form shown in FIG. 10. That is, exemplary rocker assembly 30 of FIG. 10 comprises a single arm 131 that is at least generally transversely centered on dispenser 1. Arm 131 has a proximal end 31 that is hingedly connected to first primary end 18 of dispenser 1 to provide a hinged connection 32 between rocker assembly 30 and dispenser 1. Arm 131 further has a distal end 33 that comprises a sheet-contacting member 34 of rocker assembly 30. In the depicted embodiment, a mass element 34 is disposed atop (e.g. attached to) sheet-contacting member 34; member 34 and mass element 36 are elongated along the transverse axis of dispenser 1 so that rocker assembly 30 exhibits an overall T-shape when viewed from above. Although not described in detail, rocker assembly 50 of FIG. 10 similarly comprises a single arm 132, which is arranged and functions in like manner to that described for single arm 131 of rocker assembly 30.

In general, a rocker assembly may comprise a single mass element or may comprise multiple mass elements. A single mass element may be concentrated at the distal end of the rocker assembly (e.g. as in the design of FIGS. 1-3) or it may be spread over a significant portion of the length of the rocker assembly along its primary axis. If multiple mass elements are present, they may be spaced along the primary axis of dispenser 1 and/or along the transverse axis of dispenser 1, or they may be concentrated near a central location of the dispenser. Any such mass element may be attached (by any suitable method, e.g. adhesive bonding, mechanical attachment, and so on) to any suitable portion of an arm of a rocker assembly. In some convenient embodiments, a mass element may be attached e.g. to the top of a sheet-contacting element, as with mass element 36 that is mounted atop sheet-contacting member 34 of rocker assembly 30 of FIG. 10. Any such mass element may protrude generally vertically upward from an arm and/or from a sheet-contacting member of the rocker assembly (as is the case with the exemplary mass element 36 of FIG. 10) to any desired extent. Any such a mass element may extend across the entire transverse width of dispenser 1, or may extend only partially across, or may be periodically interrupted.

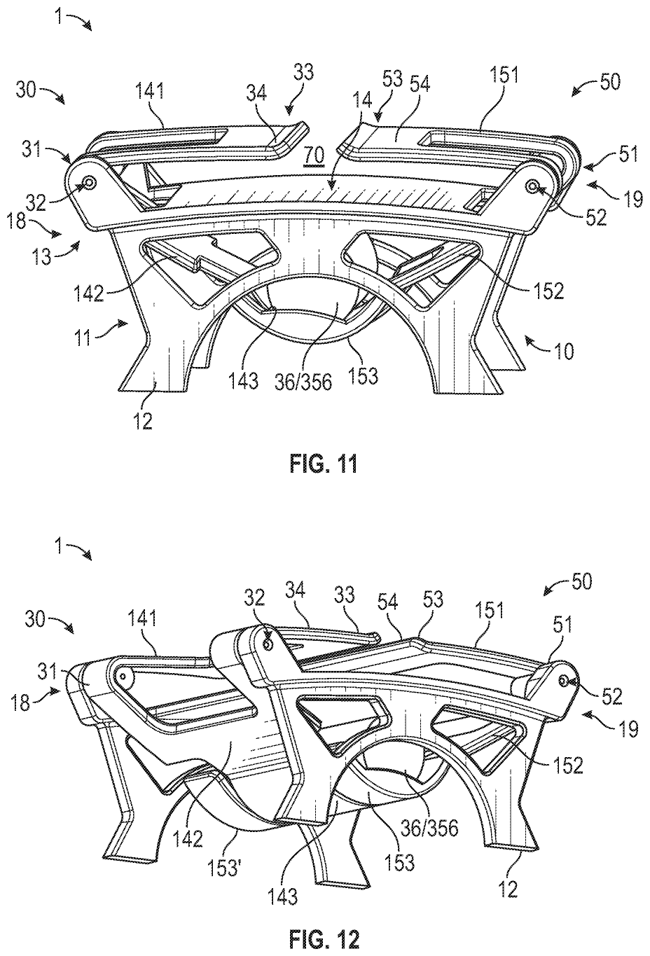

The above discussions have all involved embodiments in which a mass element is provided on a rocker assembly so that the downward force resulting from the weight of the mass element directly urges the sheet-contacting member of the rocker assembly downward. In other words, in such embodiments the mass element is positioned above the upper portion of the base of the dispenser and pushes the rocker assembly downward toward paper stack that resides in the upper portion of the base. However, in some embodiments a mass element can be positioned below the upper portion of the base and below the paper stack. Thus for example in the exemplary design of FIGS. 11 and 12, base 10 comprises an expanded vertical height to allow room for a mass element 36 (a cylinder, in this instance) to be positioned below the upper portion 13 of base 10 and below space 14 that receives the paper stack. In such a case, first rocker assembly 30 may comprise a first, upper portion 141 with a distal end 33 that comprises the first sheet-contacting member 34 of first rocker assembly 30. First rocker assembly 30 further comprises a second, lower portion 142 that is connected to first, upper portion 141 of first rocker assembly 30 at the hinged connection 32 of first rocker assembly 30 to the first primary end 18 of base 10. The resulting force from the weight of mass element 36 will push downward on the second, lower portion 142 of rocker assembly 30. This will cause first, upper portion 141 of rocker assembly 30 to rotate inward and/or downward so that sheet-contacting member 34 is pressed downward against the upper surface of a paper stack (not shown in FIGS. 11 and 12).

Similarly, second rocker assembly 50 may comprise a first, upper portion 151 with a distal end 53 that comprises second sheet-contacting member 54 of second rocker assembly 50. Second rocker assembly 50 further comprises a second, lower portion 152 that is connected to first, upper portion 151 of second rocker assembly 50 at the hinged connection 52 of second rocker assembly 50 to the second primary end 19 of base 10. First and second rocker assemblies 30 and 50 as shown in FIGS. 11 and 12 can function in a similar way to the previously-described designs, except for the positioning of the mass element. It is thus emphasized that a weighted rocker assembly as disclosed herein does not necessarily require a mass element to be placed at or near the sheet-contacting member of the rocker assembly, and in fact does not require the mass element to be positioned above the paper stack, although these can be done in many convenient embodiments as described earlier herein.

A design of the general type depicted in FIGS. 11 and 12 may have an additional attribute. Specifically, rather than using separate mass elements for the two rocker assemblies, a mass element 36 can be used that is a single, floating mass element. (Mass element number 36 of FIGS. 11 and 12 is also numbered 356 to emphasize that it is a single, floating mass element). By a floating mass element is meant that mass element 356 is not fixedly attached to either of the rocker assemblies. Rather, mass element 356 as depicted in FIGS. 11 and 12 is simply resting atop an inward area 143 of second, lower portion 142 of first rocker assembly 30, and is also resting atop an inward area 153 of second, lower portion 152 of second rocker assembly 50. Second, lower portion 142 of first rocker assembly 30 and second, lower portion 152 of second rocker assembly 50 are not attached to each other and are configured and positioned so that each lower portion does not interfere with rotatable motion of the other lower portion. In the specific arrangement of FIGS. 11 and 12, inward area 153 (that supports mass element 356) of second rocker assembly 50 is transversely split into two sections 153 and 153′; inward area 143 (that also supports mass element 356) of first rocker assembly 30 resides transversely in between the two sections of area 153, as most easily seen in FIG. 12.

These arrangements provide that when an upward force is imparted to upper portion 141 of first rocker assembly 30 (e.g. when a leading paper sheet is grasped and pulled upward as described above with reference to FIG. 7), upper portion 141 of rocker assembly 30 will rotate upward, causing lower portion 142 of rocker assembly to rotate upward. The full weight of mass element 356 will then be borne by lower portion 142 of rocker assembly 50. Similarly, during a subsequent step in the dispensing process (i.e. a sheet-separation process as described above with reference to FIG. 8), upper portion 151 of second rocker assembly 50 may rotate upward, causing lower portion 152 of second rocker assembly 50 to rotate upward. The full weight of mass element 356 will then be borne by lower portion 152 of second rocker assembly 50.

It will be appreciated that such an arrangement allows a single mass element 356 to serve as a mass element for first rocker arm assembly and also for second rocker assembly 50. That is, a single mass element can perform “double-duty” and thus may allow the weight of the mass element (and e.g. the total weight of the dispenser) to be minimized.

Dispenser 1 can be manufactured by any suitable method. It may be particularly convenient for at least some components of dispenser 1 (e.g., a base, arms of rocker assemblies, sheet-contacting members of rocker assemblies, etc.) to be injection molded. In many embodiments such components may be comprised of conventional injection moldable organic polymeric materials (e.g. polyethylene, polypropylene, polyvinyl acetate, nylon, ABS, high-impact polystyrene, and so on). As noted, if desired any such material may be filled with high density filler. Methods of making components are not limited to injection molding, however; suitable alternative methods may include e.g. vacuum forming, slush molding, compression molding, and so on. In some embodiments, at least some components of dispenser may be made by additive manufacturing methods (e.g., by so-called 3-D printing). If a mass element is made separately and then attached to one or more arms to provide a rocker assembly, the mass element may be attached in any suitable manner, e.g. by the use of an adhesive, by a press-fit or friction fit, and so on.

### List of Exemplary Embodiments

Embodiment 1 is a dispenser for dispensing sheets of paper from a fan-folded stack of sheets of paper, the dispenser exhibiting a primary axis and a transverse axis and a vertical axis and the dispenser comprising: a base with a lower portion configured to rest on a horizontal surface and with an upper portion configured to provide a space to receive and support a fan-folded stack of sheets of paper, a first rigid, weighted rocker assembly with a proximal end that is hingedly connected to a first primary end of the base and with a distal end that comprises a first sheet-contacting member; and, a second rigid, weighted rocker assembly with a proximal end that is hingedly connected to a second, opposing primary end of the base and with a distal end that comprises a second sheet-contacting member; wherein the first sheet-contacting member of the first rocker assembly and the second sheet-contacting member of the second rocker assembly collectively define a dispensing slot that is centrally located along the primary axis of the base and that exhibits a long axis that is transversely-oriented.

Embodiment 2 is the dispenser of embodiment 1 wherein the hinged connection of the first rocker assembly to the first primary end of the base establishes a first rotation axis of the first rocker assembly and wherein the hinged connection of the second rocker assembly to the second, opposing primary end of the base establishes a second rotation axis of the second rocker assembly, and wherein the first rotation axis and the second rotation axis are both aligned with the transverse axis of the dispenser.

Embodiment 3 is the dispenser of any of embodiments 1-2 wherein the first sheet-contacting member of the first rocker assembly comprises a first sheet-contacting surface that is an at least generally downward-facing surface that is arcuate along the primary axis of the dispenser and that is planar along the transverse axis of the dispenser; and, wherein the second sheet-contacting member of the second rocker assembly comprises a second sheet-contacting surface that is an at least generally downward-facing surface that is arcuate along the primary axis of the dispenser and that is planar along the transverse axis of the dispenser.

Embodiment 4 is the dispenser of any of embodiments 1-3 wherein the first rocker assembly comprises at least one mass element at least a portion of which is positioned proximate the distal end of the first rocker assembly; and, wherein the second rocker assembly comprises at least one mass element at least a portion of which is positioned proximate the distal end of the second rocker assembly.

Embodiment 5 is the dispenser of embodiment 4 wherein at least a portion of the at least one mass element of the first rocker assembly provides at least a portion of the first sheet-contacting member of the first rocker assembly so that a portion of a major surface of the at least one mass element of the first rocker assembly is a sheet-contacting surface; and, wherein at least a portion of the at least one mass element of the second rocker assembly provides at least a portion of the second sheet-contacting member of the second rocker assembly so that a portion of a major surface of the at least one mass element of the second rocker assembly is a sheet-contacting surface.

Embodiment 6 is the dispenser of any of embodiments 4-5 wherein the at least one mass element of the first rocker assembly exhibits an average density of at least 5 g/cc, and wherein the at least one mass element of the second rocker assembly exhibits an average density of at least 5 g/cc. Embodiment 7 is the dispenser of embodiment 6 wherein the at least one mass element of the first rocker assembly is made of metal and wherein the at least one mass element of the second rocker assembly is made of metal.

Embodiment 8 is the dispenser of embodiment 6 wherein the at least one mass element of the first rocker assembly comprises a molded, organic polymeric material comprising a high-density filler and wherein the at least one mass element of the second rocker assembly comprises a molded, organic polymeric material comprising a high-density filler.

Embodiment 9 is the dispenser of any of embodiments 4-8 wherein the first rocker assembly comprises first and second arms that are transversely spaced apart from each other to provide a transverse gap therebetween, and wherein each arm comprises a proximal end that is hingedly connected to the first primary end of the base so that the first and second arms collectively provide the hinged connection of the first rocker assembly to the base; and, wherein the at least one mass element of the first rocker assembly is in the form of a member that extends along the transverse axis of the dispenser to span the transverse gap between the first and second arms, a first transverse end of the member being connected to a distal end of the first arm and a second transverse end of the member being connected to a distal end of the second arm.

Embodiment 10 is the dispenser of embodiment 9 wherein the member is in the form of an elongate metal beam.

Embodiment 11 is the dispenser of any of embodiments 1-10 wherein the first rocker assembly is configured so that it can be rotated about the hinged connection, in an outward direction along the primary axis of the dispenser, to a position in which no part of the first rocker assembly vertically overlaps the space that receives and supports the fan-folded stack of sheets of paper; and, wherein the second rocker assembly is configured so that it can be rotated about the hinged connection, in a direction opposite the direction of rotation of the first rocker assembly, to a position in which no part of the second rocker assembly vertically overlaps the space that receives and supports the fan-folded stack of sheets of paper.

Embodiment 12 is the dispenser of any of embodiments 1-11 wherein the wherein the first rocker assembly comprises a single arm that is transversely centered on the dispenser and that comprises a proximal end that is hingedly connected to the first primary end of the base to provide the hinged connection between the first rocker assembly and the base; and, wherein the single arm comprises a distal end that comprises the sheet-contacting member of the first rocker assembly.

Embodiment 13 is the dispenser of any of embodiments 1-13 wherein the upper portion of the base that is configured to provide a space to receive and support a fan-folded stack of sheets of paper, comprises an arcuate major surface that is arcuate and upwardly-convex along the primary axis of the dispenser and that is planar along the transverse axis of the dispenser.

Embodiment 14 is the dispenser of any of embodiments 1-13 further comprising a fan-folded stack of sheets of paper received in the space provided by the upper portion of the base.

Embodiment 15 is the dispenser of any of embodiments 1-14 wherein an upper end of an uppermost sheet of paper of the fan-folded stack of sheets of paper protrudes at least generally upwardly through the dispensing slot collectively defined by the first sheet-contacting member of the first rocker assembly and the second sheet-contacting member of the second rocker assembly.

Embodiment 16 is the dispenser of embodiment 15 wherein at least one transverse sidewall of the fan-folded stack of sheets of paper is an exposed sidewall that is not transversely outwardly bounded by a transverse sidewall of the base of the dispenser.

Embodiment 17 is the dispenser of any of embodiments 1-3 and 13-16 wherein: the first rocker assembly comprises a first, upper portion with a distal end that comprises the first sheet-contacting member of the first rocker assembly, and wherein the first rocker assembly further comprises a second, lower portion that is connected to the first, upper portion of the first rocker assembly at the hinged connection of the first rocker assembly to the first primary end of the base, and, the second rocker assembly comprises a first, upper portion with a distal end that comprises the second sheet-contacting member of the second rocker assembly, and wherein the second rocker assembly further comprises a second, lower portion that is connected to the first, upper portion of the second rocker assembly at the hinged connection of the second rocker assembly to the second primary end of the base, and, wherein the dispenser further comprises a single, floating mass element that is positioned vertically beneath the space that receives and supports the fan-folded stack of sheets of paper and that rests atop an inward area of the second, lower portion of the first rocker assembly and atop an inward area of the second, lower portion of the second rocker assembly.

Embodiment 18 is the dispenser of any of embodiments 1-16 wherein the first rocker assembly exhibits a total weight of from 50 grams to 150 grams and wherein the second rocker assembly exhibits a total weight of from 50 grams to 150 grams and wherein the dispenser, exclusive of any fan-folded stack of sheets of paper installed therein, exhibits a total weight of from 100 grams to 400 grams.

Embodiment 19 is the dispenser of any of embodiments 1-18 wherein the hinged connection of the proximal end of the first rocker assembly to the first primary end of the base is a multi-piece hinge that is not a living hinge; and, wherein the hinged connection of the proximal end of the second rocker assembly to the second primary end of the base is likewise multi-piece hinge that is not a living hinge.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). To the extent that there is any conflict or discrepancy between this specification as written and the disclosure in any document that is incorporated by reference herein but to which no priority is claimed, this specification as written will control.

What is claimed is:

1. A dispenser for dispensing sheets of paper from a fan-folded stack of sheets of paper, the dispenser exhibiting a primary axis and a transverse axis and a vertical axis and the dispenser comprising:
a base with a lower portion configured to rest on a horizontal surface and with an upper portion configured to provide a space to receive and support a fan-folded stack of sheets of paper,
a first rigid, weighted rocker assembly with a proximal end that is hingedly connected to a first primary end of the base and with a distal end that comprises a first sheet-contacting member;
and,
a second rigid, weighted rocker assembly with a proximal end that is hingedly connected to a second, opposing primary end of the base and with a distal end that comprises a second sheet-contacting member;
wherein the first sheet-contacting member of the first rocker assembly and the second sheet-contacting member of the second rocker assembly collectively define a dispensing slot that is centrally located along the primary axis of the base and that exhibits a long axis that is transversely-oriented.

2. The dispenser of claim 1 wherein the hinged connection of the first rocker assembly to the first primary end of the base establishes a first rotation axis of the first rocker assembly and wherein the hinged connection of the second rocker assembly to the second, opposing primary end of the base establishes a second rotation axis of the second rocker assembly, and wherein the first rotation axis and the second rotation axis are both aligned with the transverse axis of the dispenser.

3. The dispenser of claim 1 wherein the first sheet-contacting member of the first rocker assembly comprises a first sheet-contacting surface that is an at least generally downward-facing surface that is arcuate along the primary axis of the dispenser and that is planar along the transverse axis of the dispenser; and, wherein the second sheet-contacting member of the second rocker assembly comprises a second sheet-contacting surface that is an at least generally downward-facing surface that is arcuate along the primary axis of the dispenser and that is planar along the transverse axis of the dispenser.

4. The dispenser of claim 1 wherein the first rocker assembly comprises at least one mass element at least a portion of which is positioned proximate the distal end of the first rocker assembly; and, wherein the second rocker assembly comprises at least one mass element at least a portion of which is positioned proximate the distal end of the second rocker assembly.

5. The dispenser of claim 4 wherein at least a portion of the at least one mass element of the first rocker assembly provides at least a portion of the first sheet-contacting member of the first rocker assembly so that a portion of a major surface of the at least one mass element of the first rocker assembly is a sheet-contacting surface; and,
wherein at least a portion of the at least one mass element of the second rocker assembly provides at least a portion of the second sheet-contacting member of the second rocker assembly so that a portion of a major surface of the at least one mass element of the second rocker assembly is a sheet-contacting surface.

6. The dispenser of claim 4 wherein the at least one mass element of the first rocker assembly exhibits an average density of at least 5 g/cc, and wherein the at least one mass element of the second rocker assembly exhibits an average density of at least 5 g/cc.

7. The dispenser of claim 6 wherein the at least one mass element of the first rocker assembly is made of metal and wherein the at least one mass element of the second rocker assembly is made of metal.

8. The dispenser of claim 6 wherein the at least one mass element of the first rocker assembly comprises a molded, organic polymeric material comprising a high-density filler and wherein the at least one mass element of the second rocker assembly comprises a molded, organic polymeric material comprising a high-density filler.

9. The dispenser of claim 4 wherein the first rocker assembly comprises first and second arms that are transversely spaced apart from each other to provide a transverse gap therebetween, and wherein each arm comprises a proximal end that is hingedly connected to the first primary end of the base so that the first and second arms collectively provide the hinged connection of the first rocker assembly to the base;
and,
wherein the at least one mass element of the first rocker assembly is in the form of a member that extends along the transverse axis of the dispenser to span the transverse gap between the first and second arms, a first transverse end of the member being connected to a distal end of the first arm and a second transverse end of the member being connected to a distal end of the second arm.

10. The dispenser of claim 9 wherein the member is in the form of an elongate metal beam.

11. The dispenser of claim 1 wherein the first rocker assembly is configured so that it can be rotated about the hinged connection, in an outward direction along the primary axis of the dispenser, to a position in which no part of the first rocker assembly vertically overlaps the space that receives and supports the fan-folded stack of sheets of paper;
and,
wherein the second rocker assembly is configured so that it can be rotated about the hinged connection, in a direction opposite the direction of rotation of the first rocker assembly, to a position in which no part of the second rocker assembly vertically overlaps the space that receives and supports the fan-folded stack of sheets of paper.

12. The dispenser of claim 1 wherein the wherein the first rocker assembly comprises a single arm that is transversely centered on the dispenser and that comprises a proximal end that is hingedly connected to the first primary end of the base to provide the hinged connection between the first rocker assembly and the base;
and,
wherein the single arm comprises a distal end that comprises the sheet-contacting member of the first rocker assembly.

13. The dispenser of claim 1 wherein the upper portion of the base that is configured to provide a space to receive and support a fan-folded stack of sheets of paper, comprises an arcuate major surface that is arcuate and upwardly-convex along the primary axis of the dispenser and that is planar along the transverse axis of the dispenser.

14. The dispenser of claim 1 further comprising a fan-folded stack of sheets of paper received in the space provided by the upper portion of the base.

15. The dispenser of claim 1 wherein an upper end of an uppermost sheet of paper of the fan-folded stack of sheets of paper protrudes at least generally upwardly through the dispensing slot collectively defined by the first sheet-contacting member of the first rocker assembly and the second sheet-contacting member of the second rocker assembly.

16. The dispenser of claim 15 wherein at least one transverse sidewall of the fan-folded stack of sheets of paper is an exposed sidewall that is not transversely outwardly bounded by a transverse sidewall of the base of the dispenser.

17. The dispenser of claim 1 wherein:
the first rocker assembly comprises a first, upper portion with a distal end that comprises the first sheet-contacting member of the first rocker assembly, and wherein the first rocker assembly further comprises a second, lower portion that is connected to the first, upper portion of the first rocker assembly at the hinged connection of the first rocker assembly to the first primary end of the base,
and,
the second rocker assembly comprises a first, upper portion with a distal end that comprises the second sheet-contacting member of the second rocker assembly, and wherein the second rocker assembly further comprises a second, lower portion that is connected to the first, upper portion of the second rocker assembly at the hinged connection of the second rocker assembly to the second primary end of the base,
and,
wherein the dispenser further comprises a single, floating mass element that is positioned vertically beneath the space that receives and supports the fan-folded stack of sheets of paper and that rests atop an inward area of the second, lower portion of the first rocker assembly and atop an inward area of the second, lower portion of the second rocker assembly.

18. The dispenser of claim 1 wherein the first rocker assembly exhibits a total weight of from 50 grams to 150 grams and wherein the second rocker assembly exhibits a total weight of from 50 grams to 150 grams and wherein the dispenser, exclusive of any fan-folded stack of sheets of paper installed therein, exhibits a total weight of from 100 grams to 400 grams.

19. The dispenser of claim 1 wherein the hinged connection of the proximal end of the first rocker assembly to the first primary end of the base is a multi-piece hinge that is not a living hinge; and, wherein the hinged connection of the proximal end of the second rocker assembly to the second primary end of the base is likewise multi-piece hinge that is not a living hinge.
